(19) United States
(12) Patent Application Publication
(10) Pub. No.: US 2009/0172720 A1
(43) Pub. Date: Jul. 2, 2009

(54) HANDLING METADATA BASED ON USER BEHAVIOR

(75) Inventors: Arto Tapio Kiiskinen, Kirkkonummi (FI); Tom Sederlof, Helsinki (FI); Martin Jansky, Espoo (FI); Kari Juhani Karkkainen, Espoo (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/966,259

(22) Filed: Dec. 28, 2007

(51) Int. Cl. H04H 60/33

(52) U.S. Cl. 725/9

(57) ABSTRACT

A device and method for receiving media data and related metadata are presented. Metadata is updated regularly in order to provide a user with instant accessibility to the media data contained in the received data stream. In order to reduce power consumption for the reception of metadata in cases when a user doesn't use a receiver for consumption of media data, update times for updating metadata are adjusted, so that still a good usability is maintained.

The technology relates generally to handling received metadata associated with media data, such as SI (System Information) or ESG (Electronic Service Guide) data that is received in the context of a mobile video or TV reception.

### BACKGROUND

Media data is increasingly consumed by users through home and mobile devices. Media data comprises all information that is recognized by a user through one of the human senses like vision and hearing, touch and scent. Examples include television and radio broadcasting, among others. While visual and audio information are ubiquitous, tactile information is also used for example for gaming or haptic feedback on a keyboard.

Media data can be received by a receiver or read out from a storage medium. Media data can be received or stored in analogue or digital format. After reception or reading, media data is processed within the device for reproduction. It is then played back through a user interface, like a video screen and loudspeakers.

Media data is often accompanied by metadata that describe further aspects of the media data. The metadata may, for example, comprise the author or composer of the media data, names of one or more performers, time and place of recording, and the like. In media data delivery, like audio or video streaming, metadata may also comprise date and time of delivery, channel access data, like access keys for encrypted pay-TV channels or Session Description Protocol (SDP) files that show the IP address from which the access keys may be obtained. Metadata may comprise metadata of only a single media data delivery or of a certain number of media data deliveries, e.g. several or all of the television programs of a TV system.

Metadata may be transmitted in the same transmission as the media data. For example, in a number of digital or analogue broadcasts, metadata is transmitted in a logical channel accompanying the media data in intervals. So, an active receiver of the broadcast listens continuously to the logical channel in order to receive updates of the metadata.

Alternatively or in addition to the transmissions of metadata in the logical channel, metadata can be transmitted on a separate broadcast channel, a multicast channel or a unicast channel. For example, metadata can be sent on a mobile telephone channel, e.g. GSM, GPRS, UMTS, or a wireless channel, e.g. WLAN, WiMAX or Bluetooth™.

Furthermore, it is possible to send metadata only upon request from the device if the channel for transmission of metadata is a bidirectional channel.

Media data may be transferred to a user by a multicast or broadcast system. The system may be analogue or digital. In an analogue television system (e.g. NTSC, PAL or SECAM), metadata is for example incorporated in the form of videotext or teletext information. In an analogue radio system (e.g. FM radio) metadata may be included e.g. in the form compatible with the Radio Data System (RDS) system for FM radio. In this context, the metadata includes not only information on the current radio transmission, but also information about system parameters like program identification, alternate frequencies for the same transmission, traffic program identification, language code etc.

In a digital radio system (e.g. Digital Radio Mondiale, Digital Audio Broadcast DAB and its further development to Digital Multimedia Broadcasting DMB) metadata may be included e.g. in the form of a further logical or physical data channel.

There are various implementations of metadata in relation to TV and radio channels of a digital TV or radio system. A digital television or audio broadcast typically comprises several television channels. This may be reflected by the metadata structure. For example, metadata may relate to a single television or audio broadcast channel only, and several separate data structures of metadata are transmitted, each belonging to a single television or audio channel. Alternatively, a single data structure of metadata may relate to two or more television or audio channels. Thus, the number of data structures containing metadata is reduced. In another alternative, only a single data structure containing metadata of all television or audio channels belonging to the television or audio broadcast is transmitted.

Media data is received by a user with a receiver, like a digital TV receiver that is installed in the user's home. However, nowadays there are also more and more mobile devices that are capable of receiving digital or analogue broadcasts. Such devices can include an analogue or digital receiver as the only application, or they can include further applications. Such further applications comprise further receiving applications (like a telephone application) or non-receiving applications (like a music-player, calendar, digital camera etc.). All of these applications are controlled and coordinated by a microprocessor/controller. Typically, in such a device a receiving application is run as software on the microprocessor. The receiving application then controls the hardware blocks needed for radio frequency (RF) reception of the broadcast signal.

The concept of delivery of metadata that accompanies a media data delivery has been developed further in digital video transmission systems like MediaFLO™ and DVB (Digital Video Broadcasting, which has been standardized as DVB-S for satellite, DVB-C for cable, DVB-T for terrestrial or DVB-H for mobile transmission). In these areas, metadata is often referred to as SI (System Information) or ESG (Electronic Service Guide) data. SI data may comprise information about the association of programs with transport streams, the physical network, conditional access (as e.g. used in Pay-TV) of the programs/transport streams, services contained in the system, time and date, etc. ESG data may comprise a program guide for one or more channels, which indicates the transmission of programs during a certain time span. Service guide information is, for example, information on the timings of a transmission, the contents of a transmission (e.g. a summary of the plot of a movie, the characters and actors, director and author of the screenplay, date of production, available language(s), subtitles and the like), information related to transmission parameters like HD transmission (high definition), stereo or surround sound etc. If the transmission is included in a commercial TV channel, service guide information may also comprise advertising and purchase information. ESG data may further comprise information for the receiver, such as the codec(s) used for encoding the media data for a particular transmission, the type of encryption used, identification of the channel and/or data stream used for transmission, signalling information and the like.

As the service information or service guide data may change over time, the service information or service guide data is sent repeatedly. Thus, the repeated transmissions of the service information or service guide data reflect the updated contents.

Reception and maintenance of all of this data at a receiver uses a certain amount of the available resources for reception by a receiver, like RF data bandwidth/throughput, processing by a processor and storing in a memory. In this context, the receiver's resources comprise both hardware resources like memory, but also processing resources like the processing power of the processor and energy resources that are needed for reception, processing and storing of data, such as a battery.

While such resources may be readily available in a fixed/static device, such as a set-top receiver connected to a main power supply, in a mobile device these resources are subject to a compromise regarding mobility on the one hand and functionality on the other hand. Thus, a number of mobile devices have a limited amount of energy available and thus need to be recharged once the stored energy is used up. The energy will last longer, if only a small amount of energy is consumed by a certain task in the device.

At intervals it is desirable to update the metadata stored in a device in order to provide the user with up to date information. A reason for this is that some metadata becomes outdated because it refers to media data that was transmitted in the past, or because the time schedule of a future transmission changes. Periodic updating of metadata also enables system parameters to be changed when necessary.

Metadata can be updated while or shortly after the receiver or the receiving application is switched on by a user, as it is used by the user to consume a piece of media data. While the receiver or the receiving application is running, further updates of metadata can be received and stored. Metadata can also be updated at times when the user is not actively consuming data. In this case, the receiver or receiving application is switched on by a scheduler, and only metadata, for example ESG data, is received. Thus, in this example, the ESG data is kept up-to-date, and the up-to-date information is immediately available the next time the user switches on the receiver or the receiving application.

It can be assumed that media data is consumed by a user when the receiver or receiving application is used by a user, i.e. when the receiver or receiving application is triggered by a signal whose root cause lies with a user, e.g. a user pressing a key at the device or on a remote control, or a user setting an alarm. By contrast, it can be assumed that no media data is consumed if the receiver or receiving application is triggered by a signal which is caused internally of the device, e.g. by a scheduler, an internally set timer or by another software application. Furthermore, the first kind of triggers will cause the start/stop or change of play back of media data on at least one part of the user interface (e.g. on a pair of headphones, a display or the like), whereas the second kind of trigger will not cause any user interface media play back or any interaction with a user.

In the arrangement described above, the scheduler may update the ESG data even though the user uses the receiver or receiving application only very rarely or not at all. This may be relevant especially in devices whose primary use is not necessarily the reception of broadcast media data. Mobile devices may contain a large number of applications providing numerous functions, and while some users may use the broadcast receiver in such a device frequently, others may use it only infrequently or not at all.

Thus regardless of the user's behaviour, the scheduler will start the receiver or receiving application which tends to increase the overall power consumption of the device and reduce its stand-by time.

### SUMMARY

This summary is not intended to identify critical or essential features of the invention, but instead merely summarizes certain features and variations thereof.

Certain embodiments include devices, systems and methods for controlling the updating of metadata related to media data such that power consumption associated with updating the metadata may be reduced, and at the same time possible negative effects on the user experience can be avoided.

According to a first aspect, there is provided a method comprising receiving media data for consumption by a user, receiving repeatedly metadata related to the media data, and determining a point in time for starting metadata reception in dependence on a consuming behaviour of the user.

According to a second aspect, an apparatus is disclosed comprising a first receiver configured to receive media data, and a second receiver configured to receive metadata that is related to the media data. However, the first and second receiver may be only one receiver, e.g. if media data and metadata are transmitted in the same transmission (e.g. on the same frequency, but in different time slots). The device may further comprise a first data storage for storing at least a part of the received metadata and/or a second data storage for storing media consumption data.

Media consumption data may be derived from the detected user behaviour. Media consumption data is data that describes the media consuming behaviour that is detected by the apparatus, e.g. by measuring parameters. The parameters measured may comprise the times a user actively consumed received media data and/or metadata. Alternatively, the measured parameters may comprise the last time a user actively consumed received media data and/or metadata.

In a further embodiment, the apparatus comprises a module for reproducing the received media data and/or the received metadata. In the case that the received media data contains video data, the module includes a video decoder and a video screen or display. For audio data, the module includes an audio decoder and a loudspeaker or an earphone. Metadata may be reproduced on a screen, or it may be read out by the device, e.g. using a text-to-speech function.

In a further embodiment, the device comprises a processor for processing media data and metadata. The processor is further configured to determine media consumption data.

In a yet further embodiment, the processor is also configured to store the media consumption data in a part of the storage. The processor is further configured to determine a point in time at which to start a next reception of metadata. This point in time may depend on the stored media consumption data.

In another embodiment, the processor runs a receiving application which controls the hardware needed for radio frequency (RF) reception of the broadcast signal. Processing of media data, metadata and media consumption data can be implemented within the receiving application.

In a further embodiment, the device is capable of running further applications in addition to the receiving application. Further applications can be for example a telephone application for starting and receiving telephone calls, a camera application for taking still images or capturing video, a music player application for play back of digital audio files (e.g. MP3, AAC, Ogg-Vorbis coded), games and other applications, and a media gallery for displaying stored media data. The received or stored media data comprises audio data and/or video data.

In an embodiment of the invention, the metadata includes Service Information (SI) or Electronic Service Guide (ESG) data, especially program guide data.

In a further embodiment, the received metadata relates to the changes of media data over time.

In a yet further embodiment, the metadata is received at times when no media data is received.

In a further embodiment of the invention, media data consumption is measured by keeping track of the usage of the receiver or receiving application. For example, a tracking unit records the last time the receiver or receiving application was used by a user. The tracking unit may also record data and calculate further statistics related to the usage of the receiver or receiving application, like average usage time, usage frequency during certain intervals, or usage of media data channels (e.g. TV channels) etc. In one embodiment, a running average for usage during the last week is calculated for all channels. In a further embodiment, the running average is calculated for TV channels separately or in groups.

In another embodiment, the tracking unit stores this data in a memory of the device. The tasks of the tracking unit may also be performed by a microprocessor or microcontroller.

In a further embodiment, the point in time for starting metadata reception is determined based on the time that has passed since media data was consumed by a user.

According to a further embodiment of the invention, scheduling the start of metadata reception is done in a manner so as the time span between two receptions of metadata is increased responsive to decreasing use of the receiver or receiving application.

According to another embodiment, further parameters are used in the determination. In one specific embodiment, the point in time when to receive the metadata is determined based on the frequency and/or duration that media data was consumed by a user during a given time span.

In a further embodiment, the receiver or receiving application receives broadcasts or multicasts as analogue or digital audio broadcasts and multicasts, and as analogue or digital video broadcasts and multicasts, like digital television transmissions.

In a further embodiment, the receiver is a television receiver, capable of receiving television media data and metadata related to the television media data. The device further comprises a first storage or memory for storing received metadata, a second storage or memory for storing media consumption data, a processor configured to determine media consumption data and to store it in the second storage. The first and second storage may be parts of a single memory. The memory may be a volatile memory like RAM, or a non-volatile memory like Flash memory.

In another embodiment, the device further comprises a display for displaying television media data and/or metadata to a user. Alternatively, it comprises a connector to connect a display, video screen or another display device. The processor is configured to schedule reception of the metadata related to the media data. The processor is further configured to determine a point for starting metadata reception in dependence on the stored media consumption data and if no media data is received at this point in time.

The time until the next reception of metadata may be increased if usage of the television receiver has been below a threshold during a pre-defined period of time.

In a further embodiment of the invention, a device is proposed comprising a first receiving means configured to receive media data, a second receiving means configured to receive metadata related to the media data, a first storage means for storing received metadata, a second storage means for storing media consumption data, a means for reproducing the received media data and/or the received metadata, a processing means configured to schedule reception of the metadata related to the media data, wherein the processing means is also configured to store media consumption data in said storage, the processing means being further configured to determine a point in time for starting metadata reception in dependence on the stored media consumption data.

Other embodiments include computer-readable storage media having executable instructions which, when executed by a processor or similar device, perform any of the various method steps described herein.

### BRIEF DESCRIPTION OF THE DRAWINGS

FIG. 1 shows an embodiment of a receiver of media data.

FIG. 2 shows a block diagram of an embodiment of a device according to the invention.

FIG. 3 shows a block diagram of logical units incorporated in a device according to the invention.

FIG. 4 shows a flow diagram of a method according to the invention.

### DETAILED DESCRIPTION

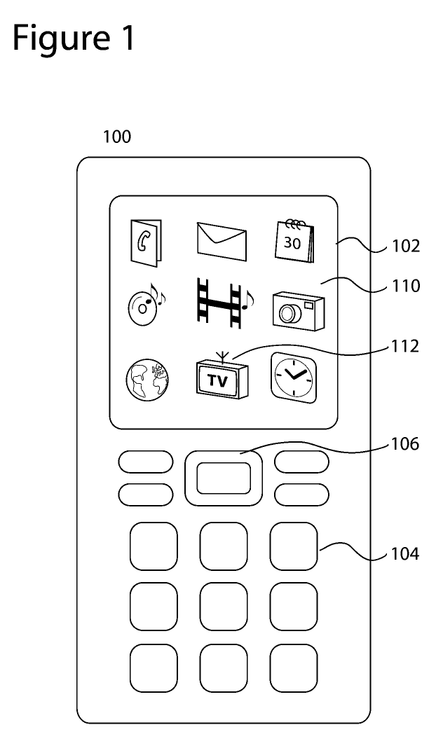

FIG. 1 illustrates an exemplary apparatus in accordance with various aspects of the invention. The apparatus may be a mobile device, such as a personal digital assistant (PDA), cellular phone, handheld multimedia device, mobile terminal, or other electronic communication device. A mobile device may also be a laptop or an accessory for a laptop, e.g. a USB device comprising a receiver for media data and metadata. The apparatus 100 comprises a display 102, a keypad 104 including a navigator key 106 to navigate on a user interface 110 shown in the display 102. The user interface 110 shows a number of applications arranged in a grid (here: 9 applications in a 3×3 grid). In further embodiments, the applications can be shown in a list of text entries with or without an icon. Among other applications like e.g. a phonebook, message center, calendar, music player, media gallery, camera, browser and clock, there is a mobile television application 112.

By clicking on the icon of the mobile television application 112, a user starts the mobile television application. The user may watch mobile TV for a certain time. A menu option of the mobile television application enables the user to end the mobile television application.

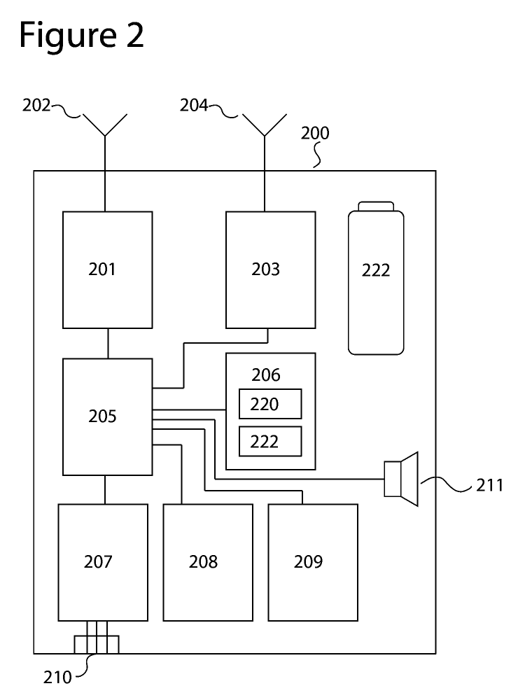

FIG. 2 shows an embodiment of the internal structure of the apparatus from FIG. 100 (here marked as apparatus 200). The apparatus 200 comprises a first receiver 201 connected to first antenna 202 and a second receiver 203 connected to second antenna 204. The first receiver 201 is, for example, a digital broadcast receiver that is used for receiving mobile television. The second receiver 203 is, for example, part of a cellular transceiver that is used for making and receiving telephone calls or for providing a data connection to the internet or some other service. In a certain embodiment, ESG data may be received along with the mobile television program reception on the first receiver 201. In this case, the second receiver 203 is not needed to perform the invention. However, in a further embodiment, metadata may be received on the second receiver 203, e.g. on a data connection to a service. As the second receiver may be bi-directional, metadata may be requested. Especially, timing critical metadata may be requested in this way, so that not all metadata is updated at a certain time.

The first receiver 201 is connected to a microprocessor 205. Received data may thus be processed by the microprocessor and shown on a display 208. Sound data may be reproduced on a speaker 211. The device 200 also comprises a memory 206 connected to microprocessor 205 in which data may be stored. For example, memory 206 comprises a section 220 for storing received metadata. Microprocessor 205 stores the received metadata in memory 206. In addition, microprocessor 205 will also remove outdated metadata from memory 206. Metadata may become or be outdated if it e.g. relates to a television transmission that occurred in the past. So, the related metadata is not needed any more, and the used memory space can be released, so that it is available for new metadata.

Microprocessor 205 operates according to program code that causes it to perform certain operations. Program code, stored in memory 206, is loaded onto the device and executed (e.g. as part of the operating system or as some higher layer of control software of the device) that implements the various functions according to some embodiments.

Microprocessor 205 is configured to detect activity on the user interface (e.g. keypad, touch pad, voice commands on the microphone etc.) related to an application such as the mobile television application. Microprocessor 205 is configured to store data of the detected user activity in terms of the mobile television application in a section 222 of memory 206. For example, microprocessor 205 stores the times when a user switched the mobile television application on and off with keyboard 209. It further calculates a duration that the user used the mobile television application from the stored data. The processor may store the usage times and information concerning which channel was watched, whether program information from the program guide was looked at, etc. The stored data can be processed, so that further parameters relating to the user's behaviour can be calculated. For example, an average usage time of the mobile television application can be calculated by adding up the usage times during a given period, e.g. one month, and dividing the result by the number of times the mobile television application was used during the given period. Further, an average usage frequency can be calculated by adding up the number of times the mobile television application was used and dividing the result by the length of the period. Furthermore, average usage times and frequencies can be calculated for all or certain mobile television channels separately. In addition, a use time and an average use time of metadata can be calculated. Thus, a user profile containing the detected and calculated data for a certain user can be compiled and stored in memory. In a further embodiment, the user profile is stored only or in addition in a remote database, e.g. in the internet. If the user later uses a mobile television application on a different device, user profile data can then be downloaded from the internet and be processed or used on the different device.

According to some embodiments of the invention, the parameters calculated from the user behaviour are used to control the way that received metadata is updated. In an example use case, the user may have used the receiver or receiving application twice a day during the last month with an average usage time of 30 minutes. As it can be expected that the user will use the receiver or receiving application again soon in the future, metadata is received and updated e.g. every 2 hours. By contrast, another user may use the receiver or receiving application only 3 times during the last month with an average usage time of 45 minutes. In order to reduce power consumption, in one example metadata is received and updated e.g. only every 12 hours. In other words, metadata is received as a function of the user's consumption behaviour.

In a further example, the user uses the mobile television application at least once a day. The processor 205 controls the receiver 201 or receiver 203 to be switched on and receive metadata every 2 hours between 08:00 hours and 24:00 hours and not at all between 00:00 hours and 08:00 hours.

In a certain use case, the user doesn't use mobile television application for a first day. According to this example, the processor is thus configured to increase the times between two consecutive updates to “every 4 hours” between 08:00 hours and 24:00 hours and not at all between 00:00 hours and 08:00 hours. In the event that the user doesn't use the mobile television application for a second day, the processor is configured to increase the times between two consecutive updates to e.g. once a day after the second day.

In addition, the processor is configured to determine the times when the mobile television application was running. So it calculates that the user has used the mobile television application in the past in 95% of all cases between 18:00 hours and 22:00 hours. Thus, it sets the daily update time at 17:30 hours each day. In this way, an improved user experience can be provided for future expected user behaviour. If the user uses the mobile television application the next day from 18:30-20:30 hours, he/she will still get up-to-date metadata, e.g. ESG data.

If however the user doesn't use the mobile television application for more than a week, the processor is configured to increase the times between two consecutive updates to a maximum update interval, e.g. start reception of metadata on a certain day, once a week, at 17:30 hours. The maximum update interval may be determined in advance. For example, if metadata is always sent for the following week, then the minimum update interval is set to “once a week”.

In this way, power consumption of the apparatus can be reduced, as either the first receiver 201 or the second receiver 203 are used less frequently for data reception. In addition, less power is used in the processor 205 and memory 206, as metadata is processed and written to/read from memory less frequently. It is noted that a large proportion of power saving can be achieved by reducing the frequency of storing metadata relating to program information and removing of outdated program-related metadata. By using more than one of the parameters of the user behaviour (e.g. typical viewing times of a user, as in the example above) in the determination of update times, the usability of the ESG data is kept high, as ESG data for the user is still kept up-to-date. In the example above, ESG data was updated only once a day, 1 hour before the user used the mobile television application again. In this way, the user—at the time he/she uses the receiver or receiving application—doesn't notice that the times between two consecutive updates was increased, as metadata in the receiver is the same as with more frequent updates.

Different parts of metadata, like Service Information (SI) data and ESG data, may require different update times. Thus, in an alternative embodiment of the invention, the process of calculating update times is performed differently for different parts of SI or ESG data. For example, in a situation where the SI or ESG data comprises program guide data and channel access information, the program guide data may be valid for 3 days, while the channel access information may be valid for 14 days. In this case, the apparatus may set a maximum update interval of program guide data to 2 days and a maximum update interval of channel access information to 13 days, so that valid data for 1 day is still left in the memory at the time the update is scheduled. During the update, new program guide data for 3 days is received and new channel access information for 13 days, respectively, including a 1-day overlap. In this way, power consumption can be further reduced due to a less frequent use of the receiver (201, 203), the processor (205) and memory (206).

In a further embodiment of the invention, the mobile device is configured to differentiate between update times for SI or ESG data relating to different channels or a group of different channels. For example, program guide data for a group of programs carried on a channel or on a group of channels is valid for 3 days. In this example, this group of programs is program group 1. Further, program guide data for a program group 2 is valid for 7 days. Thus, the mobile device may set a maximum update interval when to update program guide data for program group 1 to 3 days and a maximum update interval when to update program guide data for program group 2 to 7 days. In this example, no valid data is left in the memory at the time the update is scheduled. In comparison to the previous example, in which there still was program guide data for 1 day left in memory at the time of the update, power consumption can be further reduced. Further, data for at least 1 day can still be shown to the user in the previous example, even before new SI or ESG data is received.

However, in a still further embodiment, the mobile device is configured not to differentiate between different parts of the SI or ESG data or between different programs or program groups in case that the additional power saving achieved by selecting the update periods in a manner that distinguishes between different programs and/or program groups does not outweigh the power needed for the extra receiver activity and computational effort required to handle updates of different parts of metadata separately.

In a further embodiment, the usage of metadata by a user may also be used for the determination of the maximum update interval. The usage of metadata may also be stored by the microprocessor. Statistics related to the usage of metadata can be calculated and stored in memory. So, in an embodiment of the invention, if the user uses metadata, e.g. ESG data, every day, then ESG data is updated every 2 hours. However, if the user doesn't use ESG data for a first day, then ESG data is updated only every 4 hours. If ESG data is not used for second day, then ESG data is updated only once a day.

The usage of metadata is for example determined by the microprocessor in response to the user pressing a certain ESG button or using an option “Program guide” from the mobile television application.

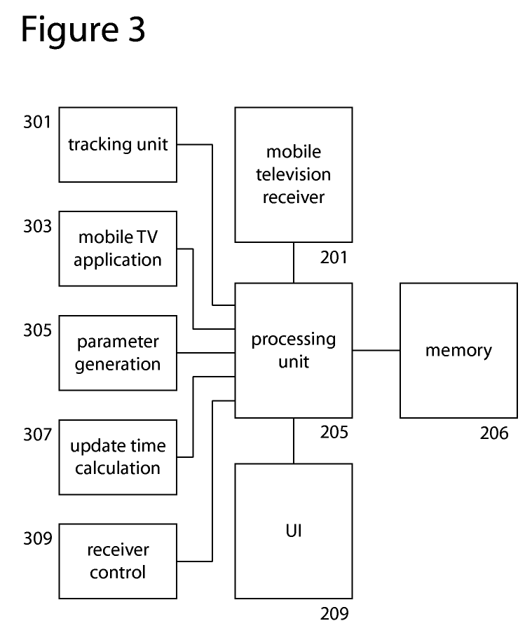

FIG. 3 shows a more functional representation of certain embodiments of the invention. Certain blocks from FIG. 2 are displayed: the first receiver 201, the microprocessor 205, the keyboard 209 and the memory 206. In addition, the figure shows a number of functional entities: tracking unit 301, mobile TV application 303, parameter generation unit 305, update time calculation unit 307 and receiver control unit 309. The functional entities may either be implemented in hardware or software. A hardware implementation of a tracking unit may be triggered by UI button presses, e.g. a button used for a mobile television application or receiver. After receiving the trigger, it copies the value of a running hardware clock into a register and stores it into a certain memory area. Likewise, a software implementation may first evaluate a keyboard interrupt in a processor. After determination that the interrupt is related to a button that is related to the mobile television application, a current value of a software clock is written into memory according to software instructions that are read from a memory and executed by the processor.

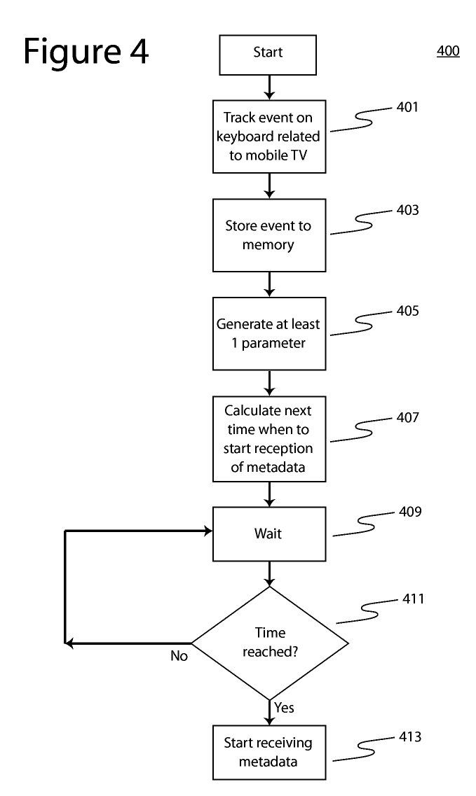

FIG. 4 shows, by use of an exemplary process 400, how the functional entities interact. In step 401 the tracking unit 301 tracks an event on the keyboard 209 related to the mobile television application 303. Such an event may be a key press related to the mobile TV application, for example a key press for switching on/off the mobile TV application, or a key press related to a change of the selected TV channel, or a key press to order some pay TV content. In a next step 403, microprocessor 205 stores the event to section 222 of memory 206. In a following step 405, parameter generation unit 305 generates at least one parameter based on the events stored in section 222 of memory 206.

Based on the at least one parameter, update time calculation unit 307 calculates a point in time for starting metadata reception, e.g. service guide information, in step 407. In one embodiment, the update time calculation unit 307 compares past usage of the mobile TV application with a pre-determined threshold. If the usage is below the threshold, then the interval up to the next time when to start reception of metadata is increased. The process then waits in step 409 until the calculated updated time is reached in 411. In step 413, the first (or second) receiver is activated to receive metadata.

In an alternate embodiment, the process advances as described above up to step 407. However, the device using the process may include a sleep mode in which an activity of one or more parts of the device may be reduced, and it may wake up regularly to do scheduled tasks. E.g. a processor in the device may wake up once per second to advance a clock shown on a display. In the context of this invention, one further task during wake up times may be to check whether the next time for receiving metadata is already reached, or even has already passed. If the time is not reached yet, no activity is started. If, however, the time is reached or has already passed, the first (or second) receiver is activated to receive metadata, as in step 413.

At any time the process may jump back to step 401 upon detection of an event by tracking unit 301.

In a further embodiment, the update time calculation unit 307 calculates a minimum and a maximum time value for receiving metadata. The minimum time value will be used when the mobile TV application is used again by a user before any of the time values expires. In a certain example, the update time calculation unit 307 calculates a minimum time value of 2 days and a maximum time value of 5 days. If the user uses the mobile TV application before the end of 2 days, then no metadata is downloaded even though the mobile TV application is running. If the user uses the mobile TV application between 2 and 5 days, then metadata is downloaded at the time the user uses the mobile TV application within this time span. If the user doesn't use the mobile TV application before the end of 5 days, then the device updates the metadata automatically by switching on the first or second receiver in order to receive the metadata.

In this way, power consumption is further reduced compared to a scenario in which metadata is always received and updated while a user uses the mobile TV application.

In an alternative embodiment, the invention may be implemented in a radio (audio) application. For example, an analogue FM (frequency modulation) radio could receive RDS data in this way. RDS data is information carried according to the “Radio Data System” specification along FM transmissions. An FM receiver could be modified in such a way that at least certain parts of RDS data are updated according to the invention. For example, alternate frequency data could be updated in this way, so that an updated list of alternate frequencies is available, even though the user hasn't actively used the FM receiver.

Also digital radio systems like DRM (Digital Radio Mondiale) or DAB (Digital Audio Broadcast) or hybrid systems like HD-Radio (Hybrid Digital/analogue Radio) that combine both digital and analogue channels may use the invention, if they provide a logical channel to carry service and/or program information.

In one embodiment, a DRM receiver receives program-associated data corresponding to a radio channel. The device containing the DRM receiver stores information related to the user behaviour using the DRM receiver to a memory. In a following step, an average usage is calculated based on the stored events. For example, it may be calculated that the average usage during the last 2 months was 0.45 times/day (this can be calculated by dividing the number of times that the receiver or receiving application was used by the number of days during the time period, e.g., 27 divided by 60 days), and the average duration was 35 minutes, and that the DRM receiver was used in 40% of the cases between 6 a.m. and 7 a.m. Thus, the device determines a point in time for starting metadata reception at two days from now at 5:30 a.m. If the user doesn't use the DRM receiver before that time, then the DRM receiver can be switched on by a microcontroller in order to receive metadata (i.e. the program-associated data). The microcontroller will then update the outdated metadata that is stored in memory.

The various aspects and embodiments of the invention described above may be implemented by way of software, hardware, or a combination thereof. Additionally, program code implementing the method according to the invention may be embodied on a computer-readable medium in the form of computer-readable instructions. Computer-readable media include any available media that can be accessed by a processor in a computing device or system. Other features of the invention will become apparent from the foregoing detailed description when taken in conjunction with the drawings.

The present invention has sometimes been described in terms of exemplary and illustrative embodiments thereof. Numerous other embodiments, modifications and variations within the scope and spirit of the appended claims will occur to persons of ordinary skill in the art from a review of this disclosure.

1. A method comprising:
receiving media data for consumption by a user,
receiving metadata related to the media data, and
determining a point in time for starting metadata reception in dependence on a consuming behaviour by the user of one or more of the media data and the metadata.

2. The method of claim 1, wherein the media data is one or more of audio data and video data.

3. The method claim 1, wherein the metadata is service guide data.

4. The method of claim 1, wherein the received metadata related to the media data changes over time.

5. The method of claim 1, wherein the next reception of metadata is started at a time when no media data is received.

6. The method of claim 1, wherein the point in time for starting metadata reception is determined based on the time that has passed since media data was last consumed by the user.

7. The method of claim 1, wherein the point in time for starting metadata reception is determined based on the frequency that media data was consumed by the user during a given time span.

8. The method of claim 1, wherein media data is one of a television and radio broadcast.

9. The method of claim 8, wherein metadata is service guide data related to at least one television channel from the one of a television and radio broadcast.

10. The method of claim 1, wherein media data consumption is measured by the use of an application on an apparatus.

11. The method of claim 10, wherein the application is a media data receiving application.

12. The method of claim 10, wherein media data consumption is measured by the time and duration when the application was used.

13. A method comprising:
receiving service guide data related to a broadcast program,
wherein the service guide data is sent repeatedly,
wherein the service guide data changes over time, and
determining a point in time for starting service guide data reception is determined based on at least one of a time and a duration when the broadcast program was received earlier.

14. An apparatus comprising:
a first receiver configured to receive media data,
a second receiver configured to receive metadata related to the media data, and
a processor configured to determine media consumption data relating to consumption of one or more of media data and metadata,
the processor being further configured to determine a point in time for starting metadata reception in dependence on the media consumption data.

15. An apparatus as in claim 14, further comprising a first memory configured to store at least a part of the received metadata.

16. An apparatus as in claim 14, further comprising second memory configured to store media consumption data.

17. An apparatus as in claim 14, further comprising a means for reproducing the received media data.

18. An apparatus as in claim 14, wherein the first receiver is a broadcast receiver.

19. An apparatus as in claim 14, wherein the first receiver and the second receiver are combined into a single receiver.

20. An apparatus as in claim 14, wherein the next reception of metadata is started at a time when no media data is received.

21. An apparatus as in claim 14, wherein the point in time for starting metadata reception is determined based on the time that has passed since media data was consumed by a user.

22. An apparatus as in claim 14, wherein the point in time for starting metadata reception is determined based on the frequency with which media data was consumed by a user during a given time span.

23. An apparatus as in claim 14, wherein media data consumption is measured with reference to use of an application on the apparatus.

24. An apparatus as in claim 23, wherein the application is a media data receiving application.

25. An apparatus as in claim 23, wherein media data consumption is measured by the time and duration when the application was used.

26. A mobile device comprising:
a television receiver configured to receive television media data and metadata related to the television media data,
a first memory configured to store received metadata,
a second memory configured to store media consumption data,
a display configured to display one or more of television media data and metadata to a user, and
a processor configured to store media consumption data in said second memory, the processor being further configured to determine a point in time for starting metadata reception in dependence on the stored media consumption data.

27. A mobile device as in claim 26, wherein the processor is configured to increase the time until the next reception of metadata if a usage of the television receiver has been below a threshold during a pre-defined duration in time.

28. An apparatus comprising
a first receiving means configured to receive media data,
a second receiving means configured to receive metadata related to the media data,
a first storage means for storing received metadata,
a second storage means for storing media consumption data,
a means for reproducing one or more of the received media data and the received metadata, and
a processing means for storing media consumption data in said second storage means, the processing means being further configured to determine a point in time for starting metadata reception in dependence on the stored media consumption data.

29. A computer-readable storage medium having encoded thereon executable instructions which, when executed by a processor, perform:
receiving media data for consumption by a user,
receiving metadata related to the media data, and
determining a point in time for starting metadata reception in dependence on a consuming behaviour by the user of one or more of the media data and the metadata.
